(19) United States
(12) Patent Application Publication
(10) Pub. No.: US 2014/0172457 A1
(43) Pub. Date: Jun. 19, 2014

(54) MEDICAL INFORMATION PROCESSING APPARATUS AND RECORDING MEDIUM

(71) Applicant: KONICA MINOLTA, INC., Tokyo (JP)

(72) Inventor: Yutaka UEDA, Tokyo (JP)

(73) Assignee: KONICA MINOLTA, INC., Tokyo (JP)

(21) Appl. No.: 14/080,752

(22) Filed: Nov. 14, 2013

(30) Foreign Application Priority Data
Dec. 14, 2012 (JP) 2012-273439

(51) Int. Cl. G06F 19/00

(52) U.S. Cl. CPC G06F 19/321
USPC 705/3

(57) ABSTRACT

A medical information processing apparatus includes: a medical image processing member to make the display member display a viewer screen for displaying an medical image including collateral information and to perform processing to the medical image; and an electronic medical record processing member to make the display member display a medical record screen for receiving input of electronic medical record information and displaying the same, and to make the storage member store the electronic medical record information correlated with the patient information, wherein the medical image processing member extracts predetermined information from the collateral information to generate text information thereof, and correlates the text information with the patient identification information, and the electronic medical record processing member inputs and displays the received text information in the new medical record input region on the medical record screen of the patient corresponding to the patient identification information.

### BACKGROUND OF THE INVENTION

1. Field of the Invention

The present invention relates to a medical information processing apparatus and a recording medium.

2. Description of Related Art

Heretofore, there has been known a medical image management apparatus (PACS: Picture Archiving and Communication System) which stores in a database medical images taken by various modalities such as Computed Radiography (CR) and Flat Panel Display (FPD) apparatuses so that the medical images are correlated respectively with pieces of patient information, manages them, and displays the medical images on a viewer screen so as to provide the same to a doctor for radiologic interpretation and diagnosis.

For example, there has been disclosed a medical image management apparatus which includes an image fetch button on a viewer screen, and when the viewer screen of a patient to be examined is opened and the image fetch button thereon is pressed, stores the medical images transmitted from the modalities so that the medical images are correlated respectively with pieces of patient information of the patient concerned, and displays the medical images on the viewer screen (for example, see Japanese Patent Application Laid-open No. 2010-124943).

The medical images are generally stored in a file format (referred to as DICOM format) in conformity with Digital Image and Communications in Medicine (DICOM) standard. The medical image in DICOM format is composed of an image portion and a header portion. In the image portion, image data of the medical image is written, and in the header portion, collateral information pertaining to the medical image is written in a description format defined by DICOM Structure Report (SR) standard. The collateral information includes basic information (patient information such as patient ID, patient name, sex, and age; image ID; photographing date and time; kind of modality; name of doctor in charge; etc.), and further includes measurement results of measurement executed based on the medical image, and annotation information (comments and so on) input with respect to the medical image.

Meanwhile, in medical facilities, the use of an electronic medical record apparatus, as well as the use of the above-described medical image management apparatus for performing radiologic interpretation and diagnosis, has been increased. The electronic medical record apparatus makes information electronically available, which information has been written in a paper medical record and is relevant to disease conditions of patients and/or prescription therefor, and stores and manages the information. The electronic medical record apparatus performs: record of electronic medical record information; transmission of treatment/prescription contents to a medical business accounting system (Receipt Computer); and so on.

However, the electronic medical record apparatus generally does not meet the DICOM standard and cannot treat DICOM-formatted medical images. For this reason, in the case of transmitting the medical image from the PACS to the electronic medical record apparatus, the DICOM-formatted medical image has been converted into a general-purpose image such as Joint Photographic Experts Group (JPEG) image, and then transmitted. In the case that a user wants to write the basic information, the measurement results, etc. included in the collateral information, in the electronic medical record information, the user needs to transcribe the collateral information displayed on the medical image in a predetermined input region in the electronic medical record apparatus, by using a keyboard or the like. Such operations are troublesome, and transcription errors are likely to occur.

### SUMMARY OF THE INVENTION

An object of the present invention is to enable easily fetching collateral information of a medical image, as electronic medical record information, without transcribing the collateral information by a user.

In order to achieve at least one of the above-described objects, a medical information processing apparatus, in which a first aspect of the present invention is reflected, includes: a display member; a storage member; medical image processing member to cause the display member to display a viewer screen for each patient, in which an medical image including collateral information in a predetermined description format is displayed, and to perform processing to the medical image displayed on the viewer screen according to an operation input from the viewer screen; and an electronic medical record processing member to cause the display member to display a medical record screen for each patient, in which electronic medical record information is input and displayed, and to cause the storage member to store the electronic medical record information which has been input from a new medical record input region on the medical record screen so that the electronic medical record information is correlated with the patient information. In the medical information processing apparatus, the medical image processing member extracts information of a predetermined item from the collateral information included in the medical image displayed on the viewer screen to generate text information of the extracted information, and correlates the text information with the patient identification information included in the collateral information to output the text information and the patient identification information to the electronic medical record processing member, and the electronic medical record processing member inputs and displays the text information, which has been output from the medical image processing member, in the new medical record input region on the medical record screen of the patient corresponding to the patient identification information.

Preferably, in the above medical information processing apparatus, the medical image processing member generates a reduced image of the medical image, and outputs the reduced image together with the text information to the electronic medical record processing member, and the electronic medical record processing member inputs and displays the reduced image together with the text information in the new medical record input region.

Preferably, the above medical information processing apparatus further includes an operation member, and in the medical information processing apparatus, the storage member stores the medical image so that the medical image is correlated with the patient information, the medical image processing member outputs storage location information of the medical image in the storage member, together with the text information, to the electronic medical record processing member, the electronic medical record processing member outputs the storage location information to the medical image processing member, when the text information displayed in the new medical record input region is operated by the operation member, and the medical image processing member reads out the medical image corresponding to the text information from the storage member, on the basis of the storage location information output from the electronic medical record processing member, and causes the display member to display the medical image.

Preferably, in the above medical information processing apparatus, the medical image processing member includes: a measuring processing member to perform measuring processing to the medical image; and a writing member to write a measurement value obtained by the measuring processing member, in the predetermined description format, in the collateral information, and the medical image processing member extracts the measurement value, which has been written in the collateral information by the writing member, to generate text information of the extracted measurement value, and correlates the text information with patient identification information included in the collateral information to output the text information and the patient identification information to the electronic medical record processing member.

Preferably, in the above medical information processing apparatus, the medical image processing member includes: an annotation information input member to receive an input of annotation information with respect to the medical image; and a writing member to write the annotation information, which has been input by the annotation information input member, in the predetermined description format, in the collateral information of the medical image, and the medical image processing member extracts the annotation information, which has been written in the collateral information by the writing member, to generate text information of the extracted annotation information, and correlates the text information with the patient information included in the collateral information to output the text information and the patient information to the electronic medical record processing member.

Preferably, in the above medical information processing apparatus, the electronic medical record processing member displays the text information and the reduced image, which have been output from the medical image processing member, in the new medical record input region, so that the text information is correlated with the reduced image.

A computer readable recording medium, in which a second aspect of the present invention is reflected, records a program causing a computer to function as: a medical image processing member to cause a display member to display a viewer screen for each patient, in which an medical image including collateral information in a predetermined description format is displayed, and to perform processing to the medical image displayed on the viewer screen according to an operation input from the viewer screen; and an electronic medical record processing member to cause the display member to display a medical record screen for each patient, in which electronic medical record information is input and displayed, and to cause a storage member to store the electronic medical record information which has been input from a new medical record input region on the medical record screen so that the electronic medical record information is correlated with the patient information, wherein the medical image processing member extracts information of a predetermined item from the collateral information included in the medical image displayed on the viewer screen to generate text information of the extracted information, and correlates the text information with the patient identification information included in the collateral information to output the text information and the patient identification information to the electronic medical record processing member, and the electronic medical record processing member inputs and displays the text information, which has been output from the medical image processing member, in the new medical record input region on the medical record screen of the patient corresponding to the patient identification information.

### BRIEF DESCRIPTION OF THE DRAWINGS

The present invention will become more fully understood from the detailed description given hereinbelow and the appended drawings, and thus are not intended as a definition of the limits of the present invention, and wherein:

FIG. 1 is a system configuration diagram of a diagnosis system;

FIG. 2 is a block diagram illustrating a functional configuration of a medical information processing apparatus;

FIG. 3 is a diagram illustrating an example of a viewer screen;

FIG. 4 is a diagram illustrating an example of a medical record viewer screen;

FIG. 5 is a diagram illustrating an example of a medical record screen;

FIG. 6 is a diagram illustrating a flow of processing to be executed by cooperation between a medical image processing section and an electronic medical record processing section when a cardiothoracic ratio is measured from the medical image in the medical information processing apparatus;

FIG. 7 is a diagram illustrating an example where a reduced image of the medical image, from which the cardiothoracic ratio has been measured, and text information of a measurement value, are displayed in a new medical record input region of the medical record screen;

FIG. 8 is a diagram illustrating a flow of processing to be executed by cooperation between the medical image processing section and the electronic medical record processing section when annotation information is input on the medical image in the medical information apparatus; and

FIG. 9 is a diagram illustrating an example where text information of the annotation information is displayed in the new medical record input region of the medical record screen.

### PREFERRED EMBODIMENT OF THE PRESENT INVENTION

Hereinafter, a preferred embodiment of the present invention will be described in detail with reference to the attached drawings. In this regard, however, the scope of the present invention is not limited to illustrated examples.

First, a configuration according to this embodiment will be described.

### [Configuration of Diagnosis System]

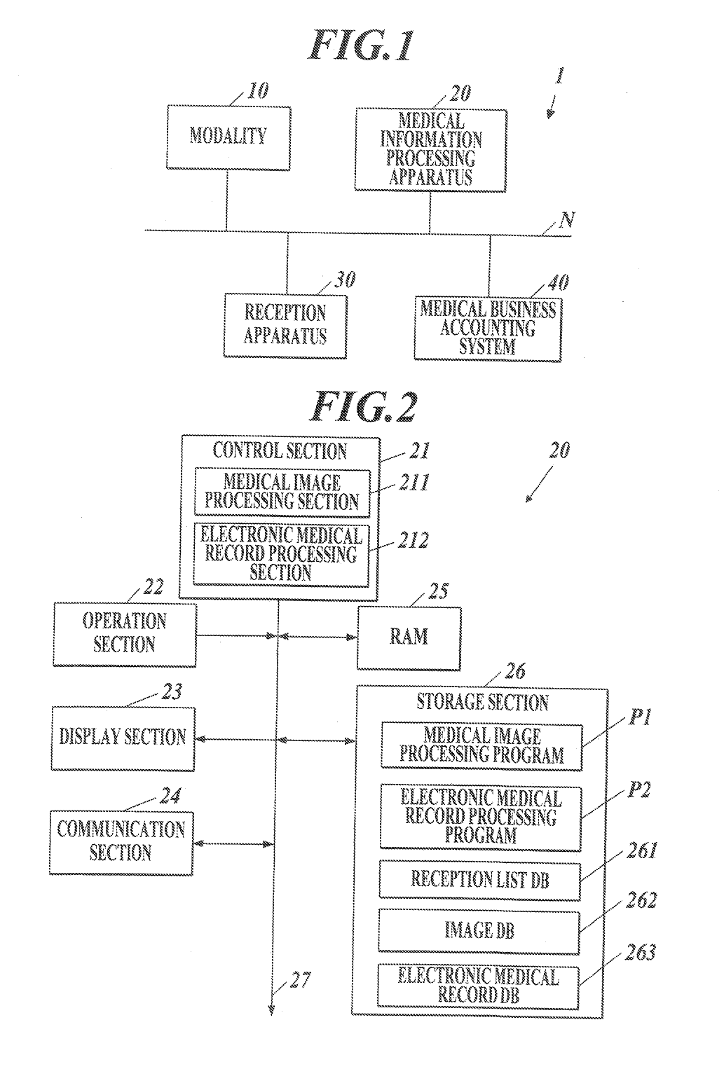

FIG. 1 illustrates an example of an overall configuration of a diagnosis system 1 according to the embodiment.

The diagnosis system 1 is a system to be applied to a relatively small-scale medical facility such as an office of a practitioner and a clinic, and as illustrated in FIG. 1, is configured to include a modality 10, a medical information processing apparatus 20, a reception apparatus 30, and a medical business accounting system 40. The respective apparatuses/systems constituting the diagnosis apparatus 1 are connected to one another so as to enable data communication among them via a communication network N such as a LAN (Local Area Network).

The modality 10 is an image generation apparatus which is installed in a photographing room and performs photographing of each diagnosis target region of each patient to generate a digital medical image. As the modality 10, there can be adopted an X-ray image photographing apparatus such as a CR apparatus and FPD apparatus, an ultrasound diagnosis apparatus (US), and so on.

In this embodiment, the modality 10 generates the medical images in DICOM format. The medical image in DICOM format is composed of an image portion and a header portion. In the image portion, image data of the medical image is written, and in the header portion, collateral information pertaining to the medical image is written in a description format defined by DICOM Structure Report (SR) standard. The collateral information includes basic information (patient information such as patient ID, patient name, sex, and age; image ID; photographing date and time; kind of modality; name of doctor in charge; etc.) pertaining to the medical image. In addition, measurement values calculated based on the medical image, annotation information input on the medical image, etc. can be written in the collateral information.

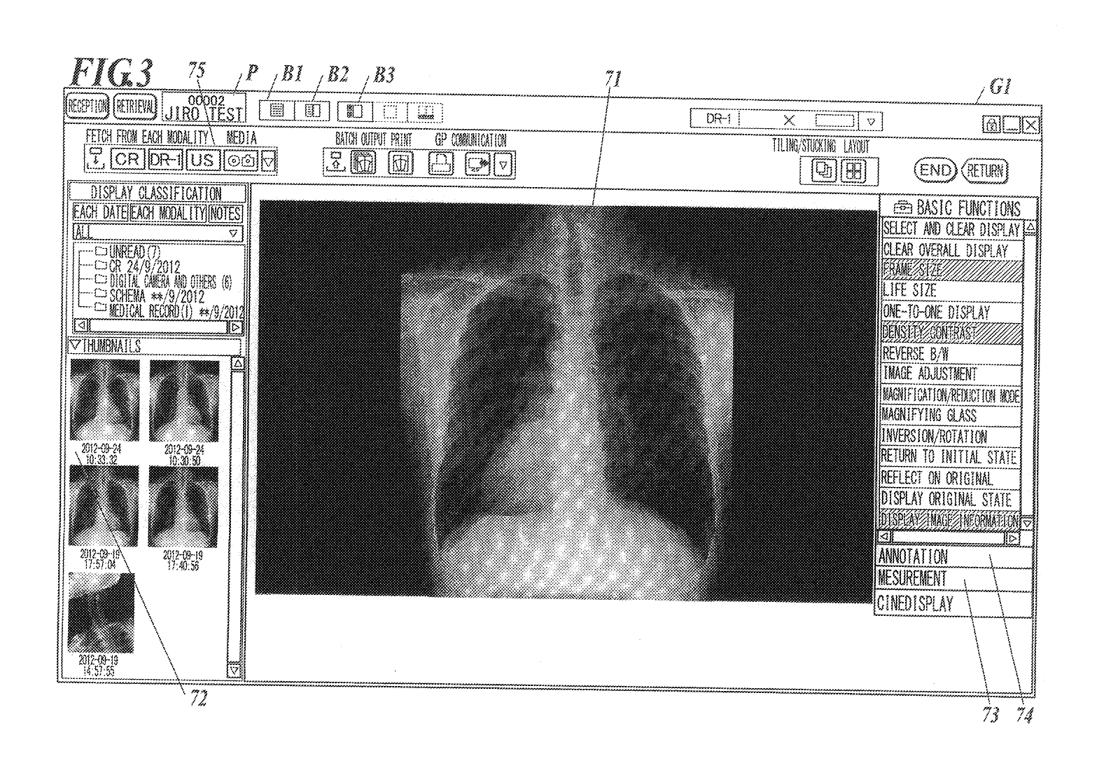

The medical information processing apparatus 20 is a computer apparatus which is installed in an examination room. The medical information processing apparatus 20 includes a medical image processing section 211 and an electronic medical record processing section 212 (see FIG. 2).

The medical image processing section 211 can recognize the collateral information contained in the medical image (DICOM-formatted medical image) generated in the modality 10. The medical information processing apparatus 20 stores and manages the medical images, displays the medical images on a viewer screen G1 (see FIG. 3), and performs various processes to the medical images displayed on the viewer screen G1 according to operations via the viewer screen G1.

The electronic medical record processing section 212 performs various processes relevant to the electronic medical record, for example, displaying a medical record screen G3 (see FIG. 5) for inputting and displaying the electronic medical record information, storing the electronic medical record information input from the medical record screen G3, transmitting medical act information and the like included in the electronic medical record information to the medical business accounting system 40, etc.

Here, the electronic medical record information is composed of the patient information (patient ID, patient name, sex, age, etc.), date, free description information, and the medical act information. The free description information is freely recorded by a doctor when he finds it necessary, and includes, for example, findings, a main complaint, past illnesses, fondness, reduced images of medical images used in diagnosis, measurement values, annotation information, and so on. The medical act information indicates a medical act that a doctor has performed to a patient, and includes, for example, an injury and disease name, medication (prescription), procedure, injection, examination/test, operation/surgery, image diagnosis, rehabilitation, and so on.

The reception apparatus 30 is a computer apparatus which is disposed at a reception desk and receives inputs of reception information (reception date, receipt number, and patient information of patient who has enrolled at the reception desk) of each patient. The reception apparatus 30 stores the reception information which has been input, and transmits the reception information to the medical information processing apparatus 20 and the medical business accounting system 40.

The medical business accounting system 40 is a computer apparatus which performs accounting calculation, calculation of insurance points, and so on. The medical business accounting system 40 receives the patient information, date, and medical act information, which are included in the electronic medical record information, from the medical information processing apparatus 20. The medical business accounting system 40 converts medical acts included in the medical act information into medical remuneration points, performs accounting calculation and/or calculation of insurance points, and generates receipt data. The receipt data is information of certificates (receipt) of medical remuneration for requesting, with regard to a medical care to the patient, payment of medical expenses to an insurer (municipality, health insurance union, etc.) from a medical institution. In the receipt data, there are written the patient information (patient name, sex, birth date, etc.), health insurance participation information of a patient, a name of medical institution as a biller, a medical department, medical act information, medical remuneration points corresponding to each medical act included in the medical act information.

Incidentally, the number of apparatuses/systems constituting the diagnosis system 1 is not particularly limited.

As a communication system in the diagnosis system 1, DICOM standard is generally used, and in communication among the respective apparatuses/systems, DICOM Modality Worklist Management (MWM) and/or DICOM Modality Performed Procedure Step (MPPS) are used.

### [Configuration of Medical Information Processing Apparatus]

FIG. 2 illustrates a functional configuration of the medical information processing apparatus 20.

As illustrated in FIG. 2, the medical information processing apparatus 20 is configured to include a control section 21, an operation section 22, a display section 23, a communication section 24, a Random Access Memory (RAM) 25, a storage section 26, and so on. The respective sections are connected to one another by a bus 27.

The control section 21 is composed of a Central Processing Unit (CPU) and others, and totally controls processing operations of respective sections of the medical information processing apparatus 20. Concretely, the CPU reads out various programs stored in the storage section 26 to expand the programs in the RAM 25, in accordance with operation signals input via the operation section 22 or instruction signals received by the communication section 24, and performs various processes in cooperation with the programs. The control section 21 functions as the medical image processing section 211 in cooperation with a medical image processing program P1. The control section 21 functions also as the electronic medical record processing section 212 in cooperation with an electronic medical record processing program P2.

The operation section 22 is composed of a keyboard which includes cursor keys, numeral input keys, various function keys, etc., and a pointing device such as a mouse, etc., and outputs to the CPU 21 operation signals input by key pressing operation with respect to a keyboard and/or by mouse operation.

The operation section 22 may has a configuration which includes a touch panel including transparent electrodes arranged in a reticular pattern so as to cover a surface of the display section 23, detects positions pressed by a finger, touch pen, etc., and transmits obtained positional information, as operational information, to the control section 21.

The display section 23 is configured to include a monitor such as an Liquid Crystal Display (LCD), and displays various screens according to instructions of display signals input from the control section 21.

The display section 23 displays a viewer screen G1, a medical record/viewer screen G2, a medical record screen G3, etc., for each patient.

FIG. 3 illustrates an example of the viewer screen G1. The viewer screen G1 is used for displaying the medical images for diagnosis made by a doctor, and/or for performing various processes to the medical images depending on operations in the operation section 22. As illustrated in FIG. 3, the viewer screen G1 includes a medical image display region 71 in which the medical image/images are displayed, a reduced image selection region 72, a measurement button 73, an annotation button 74, image fetch buttons 75, and so on.

The medical image display region 71 displays the medical images fetched from the modality 10, and/or past images of the patient (patient displayed in the patient information display region P) who is a current display object, etc., for diagnosis made by a doctor.

The reduced image selection region 72 displays the reduced images of the medical images (including the images taken in past times) of the patient who is a current display object for enabling selection of the medical image to be displayed in the medical image display region 71.

The measurement button 73 is a button for instructing to display a measurement menu. The measurement menu includes measurement of cardiothoracic ratio, measurement of pelvic, etc.

The annotation button 74 is a button for instructing to transfer to an annotation mode in which the annotation information is input on the medical image displayed in the medical image display region 71. The annotation information includes marker information such as an arrowed line indicating a pointed part on the medical image and/or character information indicating annotation and the like of the pointed part.

The image fetch buttons 75 are buttons for instructing to fetch the medical image transmitted from the modality 10 as the medical image of the patient who is a current display object. The image fetch buttons 75 are provided for respective kinds of the modalities 10, such as “CR”, “DR-1(FPD)”, and “US”. When one of the image fetch buttons 75 is pressed, the medical image transmitted from the modality 10 is correlated to the patient information of the patient as a current display object, and they are stored in the image DB 262.

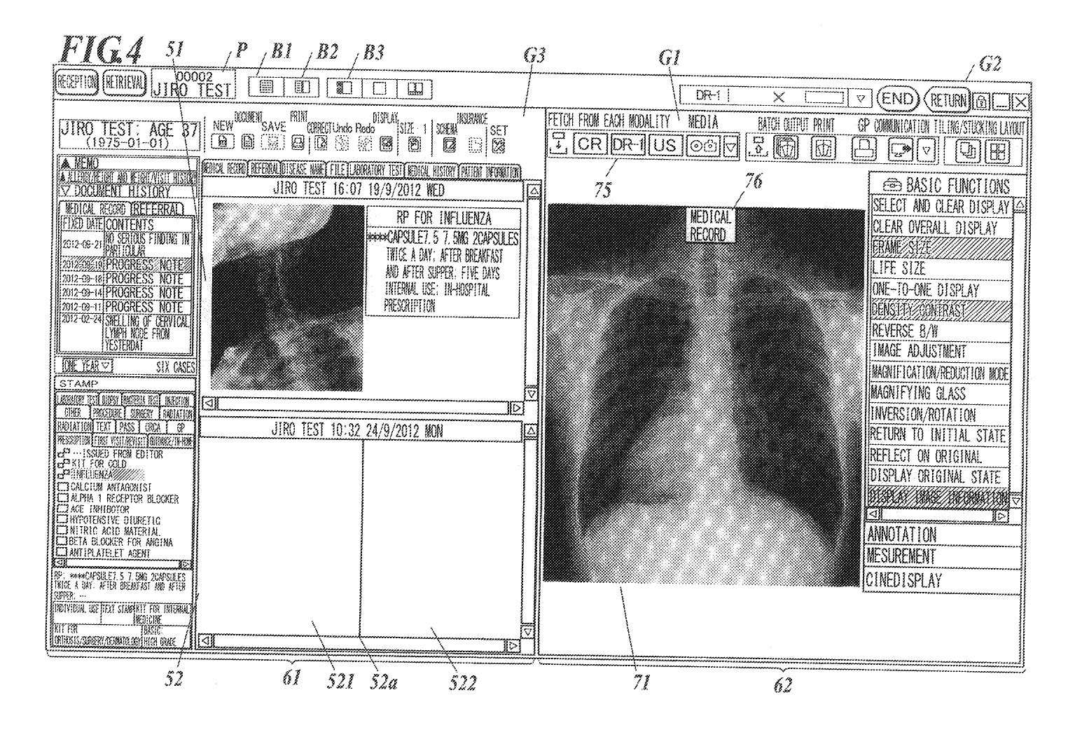

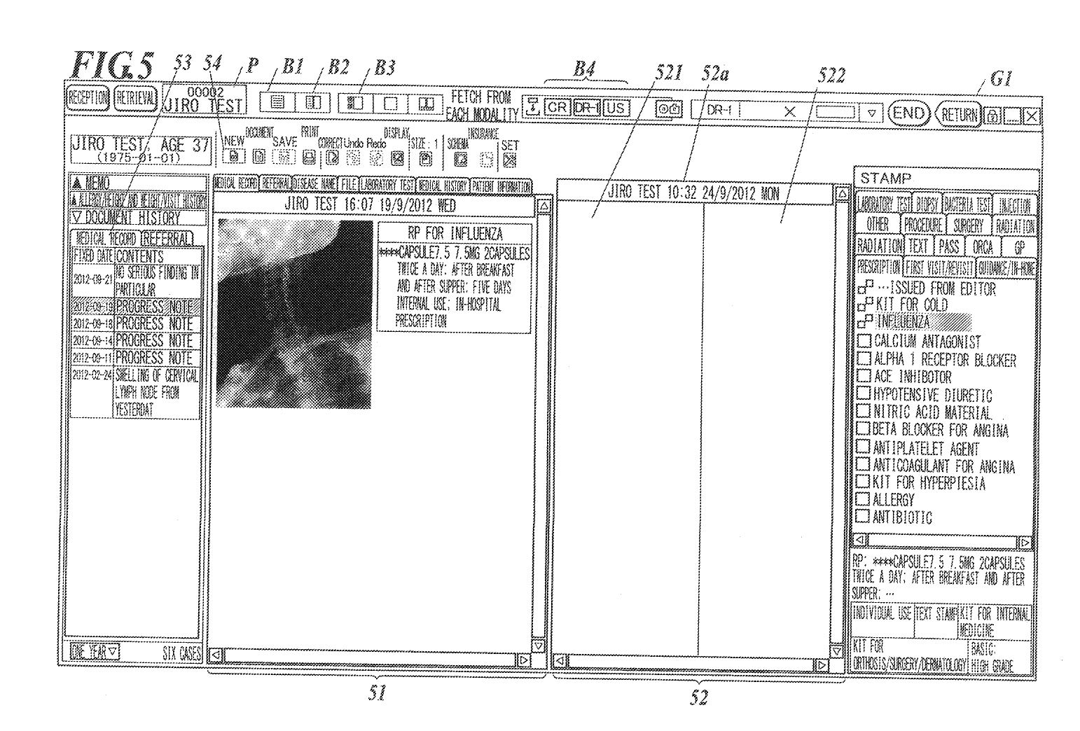

FIG. 4 illustrates an example of the medical record/viewer screen G2. The medical record/viewer screen G2 includes a region 61 in which the medical record screen G3 is displayed, and a region 62 in which the viewer screen G1 is displayed, and can display both of the screens simultaneously. In the medical image display region 71 displayed on the medical record/viewer screen G2, there is provided a medical record pasting button 76 which is used for instructing to input and display, in a new medical record input region 52a (see FIG. 5), information of a predetermined item among pieces of collateral information of the displayed medical image, and the reduced image of the medical image.

FIG. 5 illustrates an example of the medical record screen G3. As illustrated in FIG. 5, the medical record screen G3 includes a medical record display region 51, a medical record display region 52, a past medical record selection region 53, a new medical record button 54, and so on.

The medical record display regions 51, 52 are regions each of which displays a past medical record (past electronic medical record information) selected from the past medical record selection region 53, or the new medical record input region 52a for receiving an input of new electronic medical record information. Incidentally, by default, two pieces of past electronic medical record information, which have been created most recently, are displayed in the medical record display regions 51, 52, respectively.

The new medical record button 54 is a button for instructing to display the new medical record input region 52a, namely, to open a new medical record, in the medical record display region 52.

FIG. 5 illustrates an example where the new medical record input region 52a is displayed in the medical record display region 52. In the new medical record input region 52a, a free description region 521 and a medical act region 522 are provided. The free description region 521 receives an input of the above-described free description information. The medical act region 522 receives an input of the above-described medical act information.

In upper end portions of the viewer screen G1, the medical record/viewer screen G2, and the medical record screen G3, a patient information display region P and display mode selection buttons B1 to B3 are provided.

The patient information display region P is a region in which the patient information of the patient who is a current display object (diagnosis object) is displayed.

The display mode selection buttons B1 to B3 are buttons for selecting a display mode of the screen in the display section 23. The display mode selection button B1 is a button for selecting, as a screen display mode, a medical record display mode in which the medical record screen G3 is displayed over an entire area of the screen in the display section 23.

The display mode selection button B2 is a button for selecting, as the screen display mode in the display section 23, a medical record viewer display mode in which the medical record/viewer screen G2 is displayed in the display section 23.

The display mode selection button B3 is a button for selecting, as the screen display mode in the display section 23, a viewer display mode in which the viewer screen G1 is displayed in an entire area of the screen in the display section 23.

The communication section 24 is composed of a network interface and the like, and performs data transmission/reception with an external device connected to the medical information processing apparatus 20 via the communication network N. For example, the communication section 24 receives the reception information from the reception apparatus 30. The communication section 24 also receives the medical images which have been obtained by photographing a patient by using the modality 10. Moreover, the communication section 24 transmits the patient information, date, and medical act information, which are of the electronic medical record information, to the medical business accounting system 40.

The RAM 25 forms a work area for temporarily storing various programs read out from the storage section 26, input/output data, parameters, etc., in each of various processes executed/controlled by the control section 21.

The storage section 26 is composed of a Hard Disk Drive (HDD), a non-volatile memory, or the like, and stores various processing programs, and data necessary for executing these programs.

Concretely, the storage section 26 stores the medical image processing program P1, the electronic medical record processing program P2, a reception list DB 261, an image DB 262, an electronic medical record DB 263, and so on.

The medical image processing program P1 is a program for causing the control section 21 to exert functions as the above-described medical image processing section 211.

The electronic medical record processing program P2 is a program for causing the control section 21 to exert functions as the above-described electronic medical record processing section 212.

Incidentally, though this embodiment has the configuration where the medical image processing program P1 and the electronic medical record processing program P2 are stored in the storage section 26, these programs may be Software as a Service (SaaS) type that is downloaded by accessing an external data management server via an internet or the like when the medical information processing apparatus 20 is activated.

The reception list DB 261 is a database for storing reception information which has been transmitted from the reception apparatus 30 by the communication section 24 and has been received by the communication section 24.

The image DB 262 is a database for storing the medical images which have been transmitted from the modality 10 by the communication section 24, and have been received by the communication section 24, so that each medical image is correlated with each piece of the patient information.

The electronic medical record DB 263 is a database for storing the electronic medical record information generated based on the inputs on the medical record screen G3.

### [Operation of Diagnosis System]

Next, an operation of the diagnosis system 1 will be described.

This embodiment describes operations in processing when measuring a cardiothoracic ratio from the medical image, and in processing when inputting annotation on the medical image.

(Processing when Measuring Cardiothoracic Ratio)

First, the operation when the cardiothoracic ratio is measured from the medical image will be described.

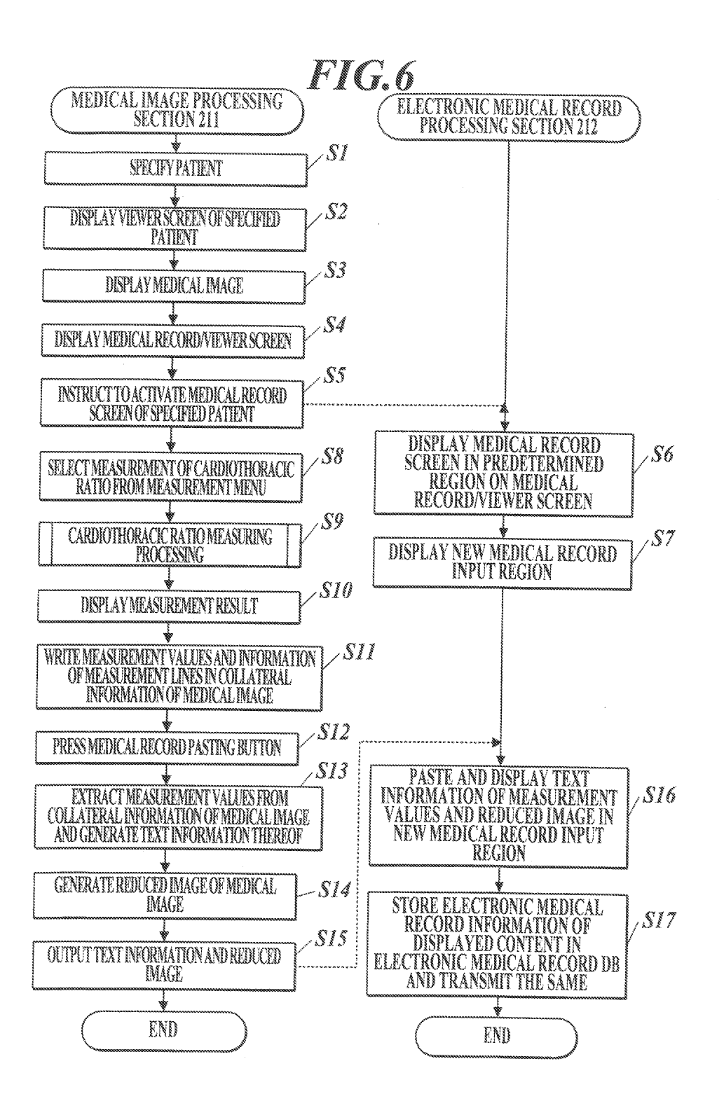

FIG. 6 is a diagram illustrating a flow of processing to be executed by cooperation between the medical image processing section 211 and the electronic medical record processing section 212 when measures the cardiothoracic ratio is measured from the medical image in the medical information processing apparatus 20. Incidentally, the display section 23 displays a reception list screen (not illustrated) in which a list of pieces of patient information stored in the reception list DB 261 is displayed.

When the patient information of the patient to be processed has been specified on the reception list screen by using an operation section 22 (Step S1), the medical image processing section 211 causes the display section 23 to display the viewer screen G1 relevant to the specified patient (Step S2). When the reduced image of the medical image (chest image, here) to be displayed in the medical image display region 71 has been selected in the reduced image selection region 72 of the viewer screen G1 by using the operation section 22, the medical image processing section 211 reads out the medical image corresponding to the selected reduced image from the image DB 262 to display the medical image in the medical image display region 71 (Step S3).

When the display mode selection button B2 on the viewer screen G1 has been pressed by using the operation section 22, the medical image processing section 211 displays a layout of the medical record/viewer screen G2 in the display section 23, displays the viewer screen G1 in the region 62 (Step S4), and instructs the electronic medical record processing section 212 to activate the medical record screen G3 relevant to the patient specified in Step S2 (Step S5).

The electronic medical record processing section 212 displays the medical record screen G3 of the patient specified in Step S1 in the region 61 on the medical record/viewer screen G2 displayed in the display section 23, according to the instruction from the medical image processing section 211 (Step S6). When the new medical record button 54 on the medical record screen G3 has been pressed by using the operation section 22, the electronic medical record processing section 212 opens new medical record of the specified patient, namely, displays the new medical record input region 52a specified in Step S1 in the medical record display region 52 on the medical record screen G3 displayed in the display section 23 (Step S7).

When the measurement button 73 has been pressed on the viewer screen G1 by using operation section 22 and measurement of cardiothoracic ratio has been selected from the measurement menu (Step S8), the medical image processing section 211 executes cardiothoracic ratio measuring processing (Step S9).

The cardiothoracic ratio measuring processing is performed depending on operations in the operation section 22 by a user. A user firstly specifies positions in which measurement lines should be drawn on the displayed medical image, by operations in the operation section 22 by a user. Concretely, a left end of heart, a right end of heart, a left end of rib cage, and/or a right end of rib cage on the medical image are specified by the operation section 22. Incidentally, because the medical image processing section 211 automatically determines the measurement line corresponding to the median line based on a middle point of a width of the rib cage, such measurement line does not need to be specified. When the positions of the measurement lines have been specified, the medical image processing section 211 causes the RAM 25 to store information (coordinates of both ends of each measurement line, line width, line color, etc.) of the specified measurement lines, and calculates the measurement values on the basis of the respective positions of measurement lines. In this case, a heart width, a rib cage width, and a cardiothoracic ratio are calculated. The heart width corresponds to a distance between the measurement line indicating the left end of heart and the measurement line indicating the right end of heart. The rib cage width corresponds to a distance between the measurement line indicating the left end of rib cage and the measurement line indicating the right end of rib cage. The cardiothoracic ratio is a ratio of the heart width to the chest width, which can be obtained by the following formula.

Cardiothoracic Ratio=(Heart Width/Rib Cage Width)×100(%)

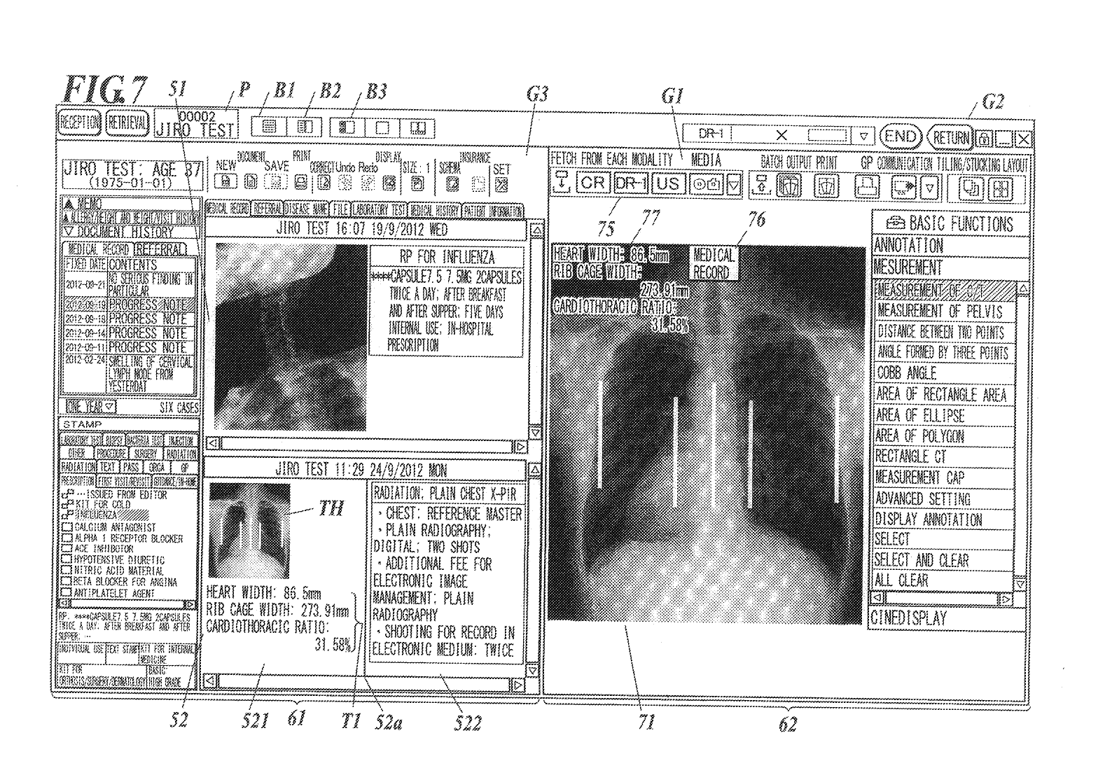

When measurement of the cardiothoracic ratio has been terminated, the medical image processing section 211 displays the measurement values 77 on the medical image in the medical image display region 71 (Step S10; see FIG. 7).

The medical image processing section 211 also writes information of measurement values and measurement lines, in the description format in conformity with DICOM SR standard, in the collateral information of the medical image which is a display object (Step S11).

When the medical record pasting button 76 is pressed by the operation section 22 (Step S12), the medical image processing section 211 extracts the measurement values obtained by the cardiothoracic ratio measuring processing, from the collateral information of the medical image which is a display object, and generates the text information of the measurement values (Step S13). Here, the text information is information (text file) of format (text format) composed of only characters, and is information of general-use format which can be recognized by general software and/or computers.

Moreover, the medical image processing section 211 reduces the medical image (including the measurement lines and measurement results) as a display object to generate the reduced images (Step S14), and outputs the text information of the generated measurement values and reduced image files, together with the patient ID and the kind of modality, to the electronic medical record processing section 212 (Step S15). The reduced images are generated as image files of general-use format which can be used in the electronic medical image processing section 212, for example, in JPEG format or the like.

When receiving the text information and the reduced image, the electronic medical record processing section 212 automatically inputs (pastes) the received text information and reduced image in the free description region 521 in the new medical record input region 52a on the medical record screen G3 so that the display section 23 displays them (Step S16).

When instruction to close the medical record screen G3 has been input by using the operation section 22, the electronic medical record processing section 212 adds the patient information of the currently-opened medical record screen G3 and date of current day to the electronic medical record information (free description information and medical act information) input from the new medical record input region 52a, and stores (saves) them in the electronic medical record DB 263. The electronic medical record processing section 212 also transmits the patient information, date, medical act information, among the pieces of electronic medical record information, to the medical business accounting system 40 by the communication section 24 (Step S17).

FIG. 7 illustrates an example where the reduced image TH of the medical image by which measurement of the cardiothoracic ratio has been performed, and the text information T1 of the measurement values are displayed in the new medical record input region 52a in Step S16. As illustrated in FIG. 7, in Step S16, the text information T1 of the measurement values and the reduced image TH of the medical image are automatically input and displayed in the free description region 521 in the new medical record input region 52a. Thus, a doctor as a user does not need to take time to input the measurement values displayed on the medical image on the viewer screen G1 in the new medical record input region 52a by using a keyboard or the like of the operation section 22, thereby user-friendliness is improved. Also transcription errors of measurement values, etc. can be prevented. Additionally, without additional operations such as fetching the reduced images of the medical images used in measurement from the modality 10 and/or the medical image management apparatus and pasting the reduced images in the new electronic medical record information, the reduced images of the medical images can be recorded as the electronic medical record information, thereby user-friendliness is improved.

Although the above embodiment describes the case that the measurement object is the cardiothoracic ratio, the measurement object is not limited thereto, and can be another portion.

(Processing when Inputting Annotation Information)

Next, the operation when annotation is input on the medical image will be described.

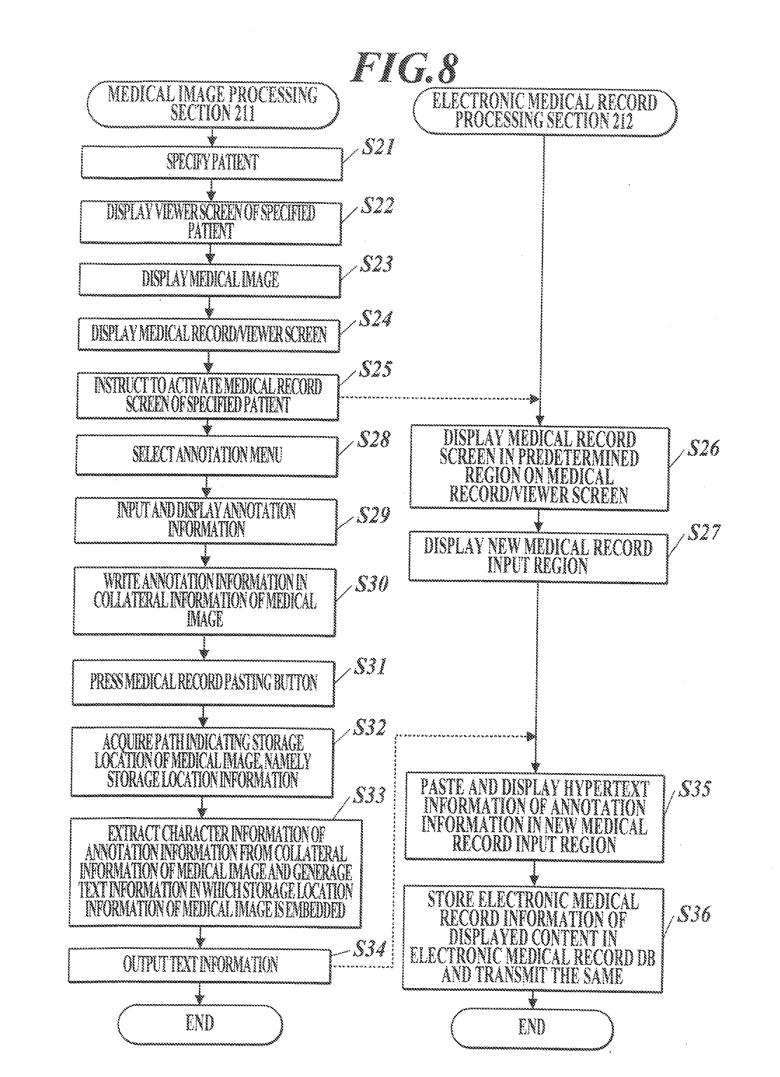

FIG. 8 illustrates a flow of processing to be executed by cooperation between the medical image processing section 211 and the electronic medical record processing section 212 when annotation information is input on the medical image in the medical information processing apparatus 20. Incidentally, the display section 23 displays a reception list screen (not illustrated) in which a list of pieces of patient information stored in the reception list DB 261.

First, processes of Step S21 to Step S27 are executed. Because the processes of Step S21 to Step S27 are similar to the above-described processes of Step S1 to Step S7, the explanation of the latter is employed by the former. Incidentally, the medical image to be displayed in Step S23 is not limited to the chest image, here.

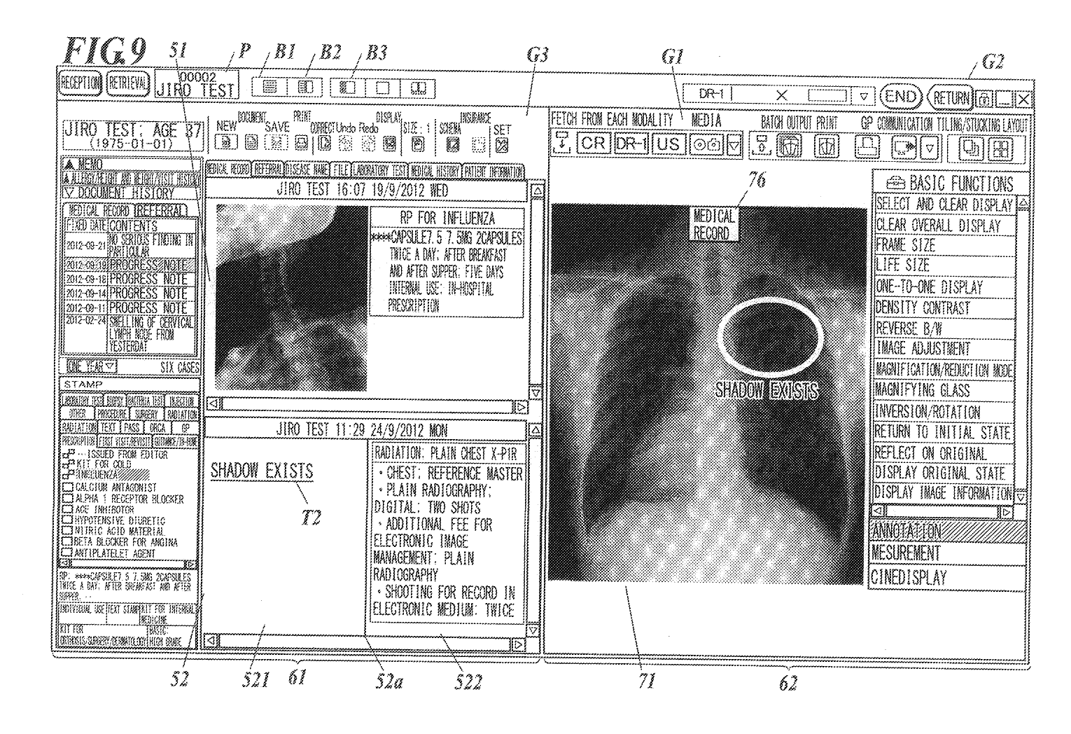

When an annotation button 74 has been pressed on the viewer screen G1 by the operation section 22 and an annotation menu has been selected (Step S28), the medical image processing section 211 makes shift to an annotation mode, receives an input of the annotation information on the medical image displayed in the medical image display region 71 by the operation section 22, and displays the input annotation information on the medical image (Step S29; see FIG. 9). The medical image processing section 211 also writes the input annotation information, in the description format in conformity with DICOM SR standard, in the collateral information of the medical image which is a display object (Step S30). As the annotation information to be written in the collateral information, for example, in addition to character information such as “shadow exists”, positional information (coordinates) of a pointed part, a kind (for example, ellipse, arrow, etc.) of a marker of the pointed part, etc. can be included.

When the medical record pasting button 76 has been pressed by using the operation section 22 (Step S31), the medical image processing section 211 acquires information (storage location information in the storage section 26) of path indicating a storage location of the medical image, to which the annotation information has been input (Step S32). The medical image processing section 211 also extracts character information of the annotation information from the collateral information of the medical image as a display object, and generates the text information (hypertext) in which the storage location information of the medical image is embedded (Step S33). Then, the medical image processing section 211 outputs the generated text information, together with the patient ID and the kind of the modality, to the electronic medical record processing section 212 (Step S34).

The electronic medical record processing section 212 automatically inputs (pastes) the text information of the annotation information output from the medical image processing section 211 in the free description region 521 in the new medical record input region 52a on the medical record screen G3 so that the display section 23 displays the text information (Step S35).

FIG. 9 illustrates an example of the text information T2 of the annotation information, displayed in the new medical record input region 52a. As illustrated in FIG. 9, in Step S35, the text information T2 of the annotation information is automatically input and displayed in the free description region 521 in the new medical record input region 52a. Thus, a doctor as a user does not need to take time to input the text information of the annotation information, which has been input on the medical image on the viewer screen G1, in the new medical record input region 52a by using a keyboard or the like of the operation section 22, thereby user-friendliness is improved. Also transcription errors of annotation information, etc. can be prevented.

When instruction to close the medical record screen G3 has been input by the operation section 22, the electronic medical record processing section 212 adds the patient information of the currently-opened medical record screen G3 and date of current day to the electronic medical record information (free description information and medical act information) input from the new medical record input region 52a, and stores (saves) them in the electronic medical record DB 263. The electronic medical record processing section 212 also transmits the patient information, date, and medical act information among the pieces of electronic, medical information to the medical business accounting system 40 by the communication section 24 (Step S36).

Here, when the electronic medical record information stored in the electronic medical record DB 263 is read out and displayed in the medical record screen G3 in the medical record display mode, the text information of the annotation information is displayed. When pressing this text information by using the operation section 22, the electronic medical record processing section 212 outputs the storage location information of the medical image, which has been embedded in the pressed text information (hypertext), to the medical image processing section 211. When receiving the storage location information, the medical image processing section 211 switches the display mode to the medical record viewer mode so that the layout of the medical record/viewer screen G2 is displayed in the display section 23, reads out the medical image, to which the annotation information has been input, from the image DB 262, on the basis of the storage location information output from the electronic medical record processing section 212, and displays the medical image in the medical image display region 71 of the viewer screen G1. In other word, a user can easily display, only by pressing the text information of the electronic medical record information displayed on the medical record screen G3 by using the operation section 22, the medical image corresponding to the text information on the same screen as the medical record screen G3.

Incidentally, also in the processing of FIG. 8, there can be adopted the configuration where the medical image processing section 211 generates the reduced image of the medical image (including the annotation information), and the electronic medical record processing section 212 inputs (pastes) and displays the reduced image, together with the text information, in the free description region 521 in the new medical record input region 52a.

As described above, according to the medical information processing apparatus 20, the medical image processing section 211 extracts the information of the predetermined item, for example, the measurement value of the cardiothoracic ratio and/or the text information of the annotation information from among the pieces of collateral information contained in the medical image displayed on the viewer screen G1, generates the text information of the extracted information, correlates the text information with the patient ID contained in the collateral information, and outputs them to the electronic medical record processing section 212. The electronic medical record processing section 212 inputs and displays the text information output from the medical image processing section 211 in the new medical record input region 52a on the medical record screen G3 of the patient corresponding to the patient ID.

Therefore, a doctor as a user does not need to take time to input the information displayed on the medical image on the viewer screen G1 in the new medical record input region 52a by using a keyboard or the like of the operation section 22, in order to fetch the information of the predetermined item of the collateral information, for example, the measurement values and/or the annotation information, and thereby user-friendliness is improved. Also transcription errors and the like can be prevented.

Moreover, by adopting the configuration where the medical image processing section 211 generates the reduced image of the medical image and outputs the reduced image together with the text information to the electronic medical record processing section 212, and the electronic medical record processing section 212 inputs and displays the reduced image together with the text information in the new medical record input region 52a, it becomes possible to record the reduced image of the medical image corresponding to the text information as the electronic medical record information, without operations of fetching the reduced image from the modality 10 and/or the medical image management apparatus and pasting it in new electronic medical record information, and thereby user-friendliness is improved.

Furthermore, in the case that the text information displayed on the medical record screen G3 is pressed by using the operation section 22, by reading out the medical image corresponding to the text information from the image DB 262 to display the medical image on the viewer screen G1, a user can refer to the medical image relevant to the text information by simple operation of pressing the text information of the electronic medical record information, and thereby user-friendliness is improved.

Incidentally, the descriptions of the above embodiment is a preferred example of the medical information processing apparatus 20 of the present invention, and the present invention is not limited thereto.

For example, though in the above embodiment the medical image processing section 211 extracts the measurement values and/or the annotation information from the collateral information of the medical image and outputs the text information thereof to the electronic medical record processing section 212, also the configuration where information of other items, such as basic information, contained in the collateral information are extracted and output to the electronic medical record processing section 212, and input in the new medical record input region 52a in the electronic medical record processing section 212, can be adopted, for example.

In the case that the electronic medical record processing section 212 displays the text information and the reduced image output from the medical image processing section 212 in the new medical record input region 52a, it is preferable to display the text information so that it is correlated with the reduced image. Displaying the text information so that it is correlated with the reduced image means displaying the text information so that a user can recognize that the text information is related to the reduced image. For example, there can be adopted means of making a color of characters of text information same as a color of image frame of the reduced image, putting the text information and the reduced image in one (1) frame, etc. By this, a user can easily recognize that the text information and the reduced image are related to each other.

Also the configuration where the medical image processing section 211 embeds the storage location information, indicating where the medical image is stored in the image DB 262, in the text information when extracting the measurement values from the collateral information of the medical image to generate the text information. When the text information displayed in the medical record screen G3 is pressed by using the operation section 22 in the electronic medical record processing section 212, the electronic medical record processing section 212 may output the storage location information embedded in the text information to the medical image processing section 211, and the medical image processing section 211 may read out the medical image corresponding to the text information from the image DB 262 on the basis of the storage location information to cause the display section 23 to display the medical image.

Additionally, though the above descriptions disclose the example where the Hard Disk Drive (HDD) and/or non-volatile memory are used as a computer readable medium which stores the programs for executing the respective processes, the present invention is not limited to the example. As another computer readable medium, a portable recording medium such as CD-ROM can be adopted. In addition, as a medium for providing data of the programs via a communication line, a carrier wave can be adopted.

Other detailed configurations and detailed operations of the medical information processing apparatus can be arbitrarily changed without departing from the spirit of the present invention.

The present U.S. patent application claims a priority under the Paris Convention of Japanese patent application No. 2012-273439 filed on Dec. 14, 2012, in which all contents of this application are disclosed, and which shall be a basis of correction of an incorrect translation.

What is claimed is:

1. A medical information processing apparatus comprising:
a display member;
a storage member;
a medical image processing member to cause the display member to display a viewer screen for each patient, in which an medical image including collateral information in a predetermined description format is displayed, and to perform processing to the medical image displayed on the viewer screen according to an operation input from the viewer screen; and
an electronic medical record processing member to cause the display member to display a medical record screen for each patient, in which electronic medical record information is input and displayed, and to cause the storage member to store the electronic medical record information which has been input from a new medical record input region on the medical record screen so that the electronic medical record information is correlated with the patient information, wherein
the medical image processing member extracts information of a predetermined item from the collateral information included in the medical image displayed on the viewer screen to generate text information of the extracted information, and correlates the text information with the patient identification information included in the collateral information to output the text information and the patient identification information to the electronic medical record processing member, and
the electronic medical record processing member inputs and displays the text information, which has been output from the medical image processing member, in the new medical record input region on the medical record screen of the patient corresponding to the patient identification information.

2. The medical information processing apparatus of claim 1, wherein
the medical image processing member generates a reduced image of the medical image, and outputs the reduced image together with the text information to the electronic medical record processing member, and
the electronic medical record processing member inputs and displays the reduced image together with the text information in the new medical record input region.

3. The medical information processing apparatus of claim 1, further comprising:
an operation member; and wherein
the storage member stores the medical image so that the medical image is correlated with the patient information,
the medical image processing member outputs storage location information of the medical image in the storage member, together with the text information, to the electronic medical record processing member,
the electronic medical record processing member outputs the storage location information to the medical image processing member, when the text information displayed in the new medical record input region is operated by the operation member, and
the medical image processing member reads out the medical image corresponding to the text information from the storage member, on the basis of the storage location information output from the electronic medical record processing member, and causes the display member to display the medical image.

4. The medical information processing apparatus of claim 1, wherein
the medical image processing member includes:
a measuring processing member to perform measuring processing to the medical image; and
a writing member to write a measurement value obtained by the measuring processing member, in the predetermined description format, in the collateral information, and
the medical image processing member extracts the measurement value, which has been written in the collateral information by the writing member, to generate text information of the extracted measurement value, and correlates the text information with patient identification information included in the collateral information to output the text information and the patient identification information to the electronic medical record processing member.

5. The medical information processing apparatus of claim 1, wherein
the medical image processing member includes:
an annotation information input member to receive an input of annotation information with respect to the medical image; and
a writing member to write the annotation information, which has been input by the annotation information input member, in the predetermined description format, in the collateral information of the medical image, and
the medical image processing member extracts the annotation information, which has been written in the collateral information by the writing member, to generate text information of the extracted annotation information, and correlates the text information with the patient information included in the collateral information to output the text information and the patient information to the electronic medical record processing member.

6. The medical information processing apparatus of claim 2, wherein
the electronic medical record processing member displays the text information and the reduced image, which have been output from the medical image processing member, in the new medical record input region, so that the text information is correlated with the reduced image.

7. A computer readable recording medium which records a program causing a computer to function as:
a medical image processing member to cause a display member to display a viewer screen for each patient, in which an medical image including collateral information in a predetermined description format is displayed, and to perform processing to the medical image displayed on the viewer screen according to an operation input from the viewer screen; and
an electronic medical record processing member to cause the display member to display a medical record screen for each patient, in which electronic medical record information is input and displayed, and to cause a storage member to store the electronic medical record information which has been input from a new medical record input region on the medical record screen so that the electronic medical record information is correlated with the patient information, wherein
the medical image processing member extracts information of a predetermined item from the collateral information included in the medical image displayed on the viewer screen to generate text information of the extracted information, and correlates the text information with the patient identification information included in the collateral information to output the text information and the patient identification information to the electronic medical record processing member, and
the electronic medical record processing member inputs and displays the text information, which has been output from the medical image processing member, in the new medical record input region on the medical record screen of the patient corresponding to the patient identification information.
